(19) United States
(12) Patent Application Publication
(10) Pub. No.: US 2012/0321320 A1
(43) Pub. Date: Dec. 20, 2012

(54) Generation and Direct Detection of Orthogonal Band Multiplexing OFDM Signal with Optical Carriers

(75) Inventor: Jianjun Yu, Basking Ridge, NJ (US)

(73) Assignee: NEC LABORATORIES AMERICA, INC., Princeton, NJ (US)

(21) Appl. No.: 13/494,227

(22) Filed: Jun. 12, 2012

Related U.S. Application Data
(60) Provisional application No. 61/497,983, filed on Jun. 17, 2011.

(51) Int. Cl. H04J 14/00

(52) U.S. Cl. 398/79

(57) ABSTRACT

The present method includes providing a continuous wave CW optical source with a fixed frequency spacing, separating multiple wavelengths of said CW optical source into different channels, modulating the multiple wavelengths of the CW optical source to generate an OFDM electrical signal with multiple sub-channels and each sub-channel has a channel subcarrier spacing , mixing the OFDM electrical signal with a radio frequency RF sinusoidal signal at a frequency ξf by an electrical mixer and generating a double sideband optical signal, filtering the double sideband signal to generate a single sideband optical signal, combining all channels of the single sideband optical signal, and directly detecting each sub-band of the single sideband optical OFDM signal with a respective detector, the detector converting the optical signal to an electrical signal for digital signal processing.

This application claims the benefit of U.S. Provisional Application No. 61/497,983, entitled “Generation and Direct Detection of Orthogonal Band Multiplexing OFDM Signal with Optical Carriers”, filed Jun. 17, 2011, of which the contents are incorporated herein by reference.

### BACKGROUND OF THE INVENTION

The present invention relates generally to optical communications and more particularly to generation and direct detection of orthogonal band multiplexing OFDM signal with optical carriers.

Optical orthogonal frequency-division multiplexing OFDM is an attractive modulation format for a forthcoming high-speed optical transmission system. However, even the spectral-efficient implementation of optical OFDM requires digital-to-analog converters (DAC) and analog-to-digital converters (ADC) to operate at a bandwidth that may not be available today or may not be cost-effective. In order to resolve the electronic bandwidth bottleneck associated with DAC/ADC devices, others have proposed use of an orthogonal-band-multiplexed OFDM (OBM-OFDM) technique to subdivide the entire OFDM spectrum into multiple orthogonal bands. With this scheme, the DAC/ADCs do not need to operate at extremely high sampling rate. However, with the OBM-OFDM technique, since there is no optical carrier in the OBM-OFDM signal, the technique has to use coherent detection for its system, which is a drawback to this OBM-OFDM scheme.

Accordingly, there is a need for a method for generating and direct-detection of an orthogonal band multiplexing OFDM signal with optical carriers without coherent detection.

### BRIEF SUMMARY OF THE INVENTION

The present invention includes providing a continuous wave CW optical source with a fixed frequency spacing, separating multiple wavelengths of said CW optical source into different channels, modulating the multiple wavelengths of the CW optical source to generate an OFDM electrical signal with multiple sub-channels and each sub-channel has a channel subcarrier spacing , mixing the OFDM electrical signal with a radio frequency RF sinusoidal signal at a frequency ξf by an electrical mixer and generating a double sideband optical signal, filtering the double sideband signal to generate a single sideband optical signal, combining all channels of the single sideband optical signal, and directly detecting each sub-band of the single sideband optical OFDM signal with a respective detector, the detector converting the optical signal to an electrical signal for digital signal processing.

These and other advantages of the invention will be apparent to those of ordinary skill in the art by reference to the following detailed description and the accompanying drawings.

### BRIEF DESCRIPTION OF THE DRAWINGS

FIG. 1 shows a conceptual diagram of orthogonal-band-multiplexed OFDM (OBM-OFDM) with optical carriers;

FIG. 2 is a diagram of an exemplary generation of orthogonal-band-multiplexed OFDM (OBM-OFDM), in accordance with the invention;

FIG. 3 is a diagram of direct detection of orthogonal-band-multiplexed OFDM (OBM-OFDM) with optical carriers, in accordance with the invention; and

FIG. 4 shows a block diagram highlighting aspects of the OBM-OFDM technique, in accordance with the invention.

### DETAILED DESCRIPTION

The present invention is directed to generating and direct-detection of an orthogonal band multiplexing OFDM signal with optical carriers without the use of coherent detection.

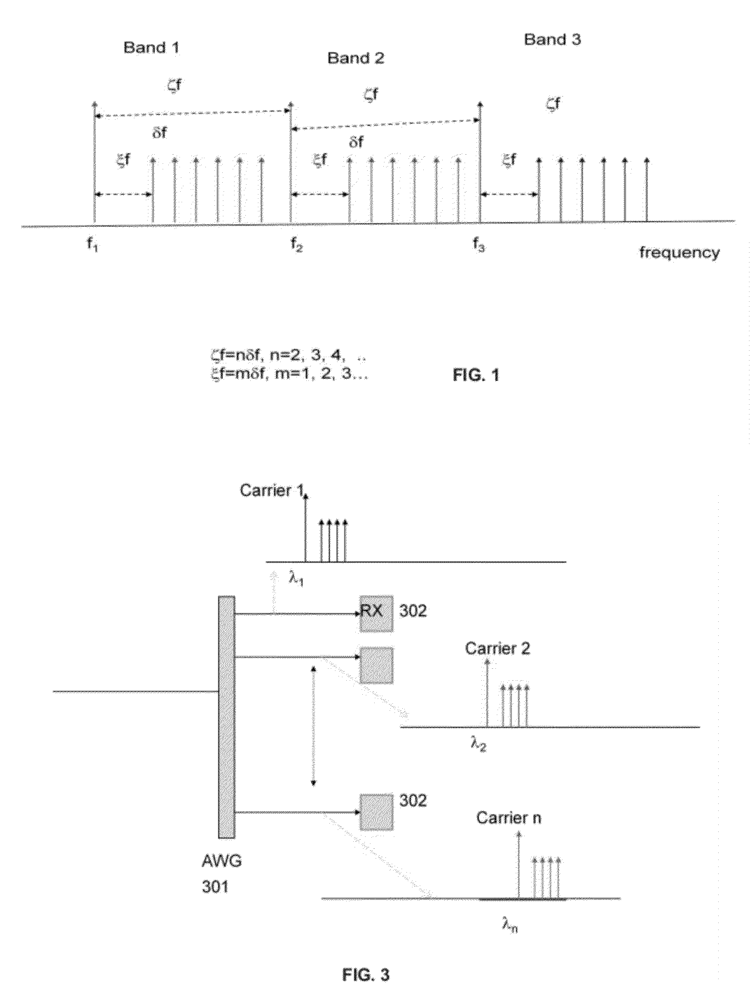

Referring now to FIG. 1, there is a conceptual diagram of orthogonal-band-multiplexed OFDM (OBM-OFDM) with optical carriers. The principle of the OBM-OFDM is to divide the entire OFDM spectrum into multiple orthogonal OFDM (sub) bands. As shown in FIG. 1, the entire OFDM spectrum comprises N OFDM bands, each with the subcarrier spacing of δf, and band frequency guard spacing between the optical carrier to the sub-carrier f2. The subcarrier spacing δf is identical for each band due to using the same sampling clock within one circuit. The orthogonal condition between the different bands is given by equation (1)

ξf=nδf, n=2, 3, 4, . . .

ξf=mδf, n=2, 3, 4, . . .

that is, the guard band (ξf) between the optical carrier to the sub-carrier is multiple (m times) of subcarrier spacing (δf), and the frequency (ξf) between the adjacent channels is multiple (n times) of subcarrier spacing (δf). This is to guarantee that each OFDM band is an orthogonal extension of another. As such, the orthogonality condition is satisfied not only for the subcarriers inside each band, but it is also satisfied for any two subcarriers from different bands, for instance, f1 from band 1 and f2 from band 2 are orthogonal to each other (FIG. 1), despite the fact that they originate from different bands.

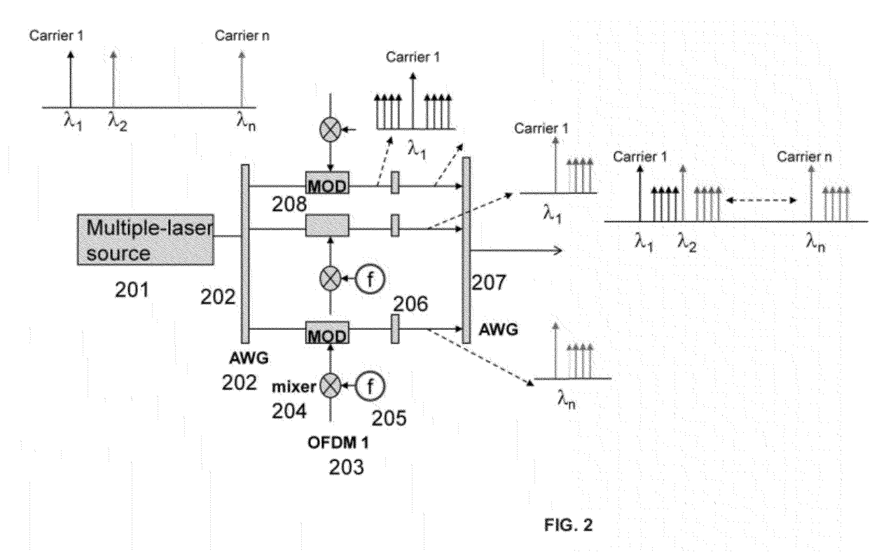

The diagram of FIG. 2 shows how to generate this orthogonal-band-multiplexed OFDM (OBM-OFDM) signal with optical carriers. A multiple laser source (201) with fixed frequency spacing ξf is employed to generate multiple wavelength CW source. The multiple wavelength CW laser source is de-multiplexed by an arrayed waveguide grating (AWG). Each laser source will be modulated by an OFDM signal. The OFDM signal has multiple sub-channels, and each sub-channel has a channel spacing of δf. The ξf and δf should meet the requirement as shown in Eq. 1. The OFDM signal (103) is mixed with a RF sinusoidal signal at ξf (104) by an electrical mixer (105). ξf and δf should meet the requirement as shown in equation 1 above. The mixed signal is used to drive the external modulator. This external modulator can be an intensity modulator, phase modulator or an I/Q modulator. If an I/Q modulator is used, the electrical mixer can be removed. After this external modulator, a double sideband optical signal will be generated. Then we can use an optical filter (106) to remove one sideband to generate single-sideband signal. After that, another arrayed wave grating AWG (107) is used to combine all channels. The optical filter can be integrated into the AWG after proper design. In this way, orthogonal-band-multiplexed OFDM (OBM-OFDM) signal with optical carriers is generated.

The diagram of FIG. 3 shows how to directly detect the orthogonal-band-multiplexed OFDM (OBM-OFDM) signal with optical carriers, in accordance with the invention. An AWG (301) is used to de-multiplex the OBM-OFDM signal with optical carrier into different sub-bands. Each sub-band will have one optical carrier and multiple sub-carriers. Therefore a direct-detection receiver can be used to detect the sub-band OFDM signal without coherent detection.

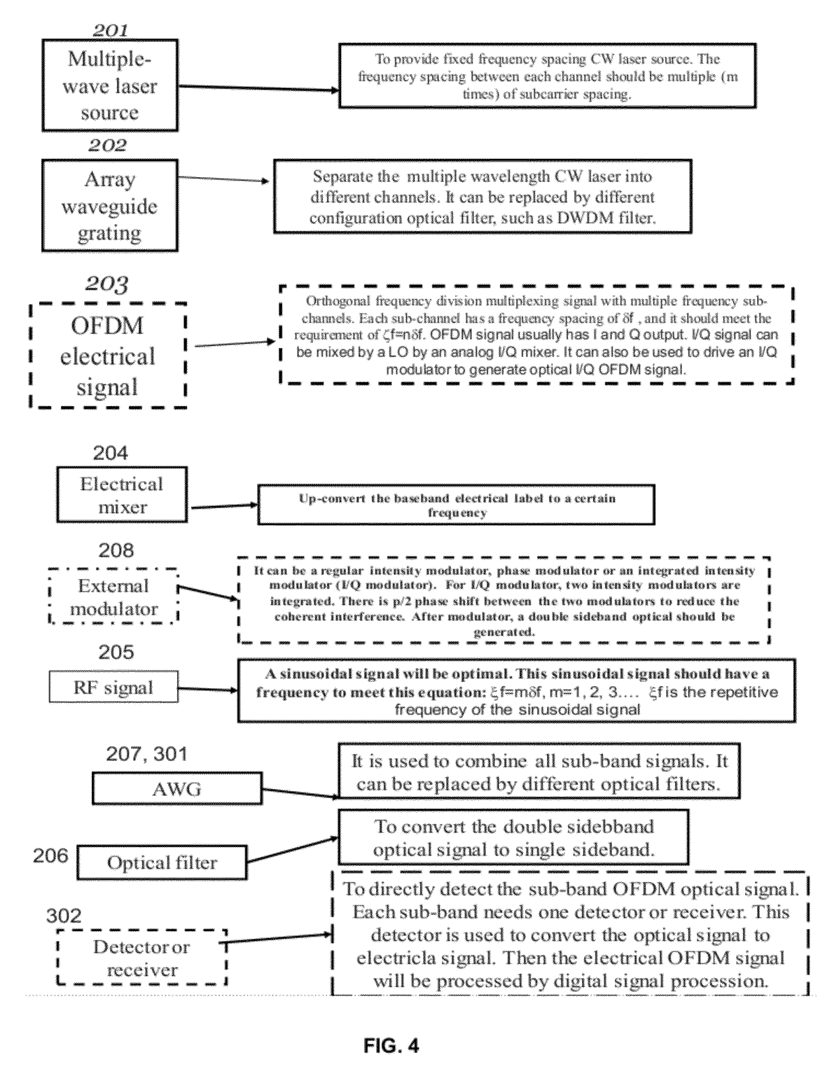

Referring to FIG. 4, the diagram highlights key aspects of the inventive OBM-OFDM optical signal generation and direct detection.

The multiple wave laser source 201 provides a fixed frequency spacing of a continuous wave CW laser source. The frequency spacing between each channel should be multiple (m times) of subcarrier spacing. The array waveguide grating 202 separates the multiple wavelength CW laser into different channels. It can be replaced by different configurations of an optical filter, such as DWDM filter.

The OFDM electrical signal 203 is an orthogonal frequency division multiplexing signal with multiple frequency sub-channels. Each sub-channel has a frequency spacing of δf, and it should meet the requirement of ξf=nδf. The OFDM signal usually has I and Q outputs. The I/Q signal can be mixed by a local oscillator LO or by an analog I/Q mixer. It can also be used to drive an I/Q modulator to generate an optical I/Q OFDM signal.

The electrical mixer 204 up-converts the baseband electrical label to a certain frequency. The external modulator 208 can be a regular intensity modulator, phase modulator or an integrated intensity modulator (I/Q modulator). For I/Q modulator, two intensity modulators are integrated. There is p/2 phase shift between the two modulators to reduce the coherent interference. After modulator, a double sideband optical should be generated. The RF signal 205 will optimally be a sinusoidal signal. This sinusoidal signal should have a frequency to meet the following equation: ξf=mδf, m=1, 2, 3 . . . ξf is the repetitive frequency of the sinusoidal signal.

The arrayed wave grating 207, 301 are used to combine all sub-band signals and can be replaced by different optical filters. The optical filter 206 converts the double sideband optical signal to a single sideband optical signal.

Turning now to the direct detector or receiver 302 coupled to the AWG 301. For directly detecting the sub-band OFDM optical signal, each sub-band needs one detector or receiver. This detector is used to convert the optical signal to electrical signal. the electrical OFDM signal can then be processed by digital signal processing.

From the foregoing, it can also be appreciated that the benefits of the inventive virtualization are substantial. The inventive direct detection OBM-OFDM without coherent detection is a simple, low cost solution that overcomes the electronic bottleneck associated with DAC/ADC devices in an optical system.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method for an optical orthogonal-band-multiplexed OBM orthogonal frequency-division multiplexed OFDM system, said method comprising the steps of:
providing a continuous wave CW optical source with a fixed frequency spacing;
separating multiple wavelengths of said CW optical source into different channels;
modulating said multiple wavelengths of said CW optical source to generate an OFDM electrical signal with multiple sub-channels and each said sub-channel has a channel subcarrier spacing of δf;
mixing said OFDM electrical signal with a radio frequency RF sinusoidal signal at a frequency of ξf by an electrical mixer and generating a double sideband optical signal;
filtering said double sideband signal to generate a single sideband optical signal;
combining all channels of said single sideband optical signal; and
directly detecting each sub-band of said single sideband optical OFDM channel with a respective detector, said detector converting the optical signal to an electrical signal for digital signal processing.

2. The method of claim 1, wherein said OFDM signal comprises a guard band frequency of ξf between adjacent channels that is a multiple n times that of said subcarrier spacing frequency of δf.

3. The method of claim 2, wherein said OFDM signal comprises a subcarrier spacing of δf and a guard band ξf with said guard band frequency of ξf between an optical carrier to a sub-carrier is a multiple m times that of said subcarrier spacing frequency of δf thereby guaranteeing that each OFDM band is an orthogonal extension of another.

4. The method of claim 3, wherein orthogonality in said OFDM multiplexing signal is satisfied not only for subcarriers inside each band, but it is also satisfied for any two subcarriers from different bands, despite the fact that they originate from different bands.
